(19) United States
(12) Patent Application Publication
(10) Pub. No.: US 2020/0180436 A1
(43) Pub. Date: Jun. 11, 2020

(54) COMPUTER SYSTEM FOR AN AUTONOMOUS VEHICLE

(71) Applicants: Somto OBIAGWU, Syracuse, NY (US); Zachariah REID, Syracuse, NY (US)

(72) Inventors: Somto OBIAGWU, Syracuse, NY (US); Zachariah REID, Syracuse, NY (US)

(21) Appl. No.: 16/789,099

(22) Filed: Feb. 12, 2020

Related U.S. Application Data
(63) Continuation of application No. PCT/US2018/045787, filed on Aug. 8, 2018.
(60) Provisional application No. 62/546,173, filed on Aug. 16, 2017.

(51) Int. Cl. B60K 35/00; B60W 50/10; B60J 3/04; B60W 60/00; G09G 3/34

(52) U.S. Cl. CPC B60K 35/00; B60W 50/10; B60J 3/04; B60W 2050/0077; G09G 3/3406; B60W 2540/215; B60W 2556/45; B60W 60/0051

(57) ABSTRACT

A computer system for an autonomous vehicle is presented. The computer system includes a display system for interfacing with a passenger within the vehicle. The display system is disposed on a window of the autonomous vehicle. A server is disposed in the vehicle. The server is in communication with the display system. The server is operable to activate the display system when an auto-pilot system of the autonomous vehicle is activated.

### CROSS REFERENCE TO RELATED APPLICATION

This application is a continuation of United States International Application No. PCT/US2018/045787, filed Aug. 8, 2018, which claims priority to U.S. Provisional Application No. 62/546,173, filed Aug. 16, 2017, the disclosures of which are hereby incorporated herein in their entirety.

### TECHNICAL FIELD

The present disclosure relates to computer systems for autonomous vehicles and methods of making the same. More specifically, the disclosure relates to a computer system for autonomous vehicles having a display system disposed on a window of the vehicle.

### BACKGROUND

Autonomous vehicles, such as self-driving cars, are rapidly developing in sophistication and reliability. As the self-driving capabilities of these vehicles develops, the need for manual control of the autonomous vehicles becomes less significant. In a fully self-driving autonomous vehicle, the passengers of the vehicle are free to perform tasks that could not be safely accomplished in manually controlled prior art vehicles. For example, when a fully autonomous vehicle is in its autopilot (self-driving) mode, passengers, including the driver, may be able to safely text on cell phones or work on their laptop computers, much like they were riding on a train.

Also, for example, when a semi-autonomous vehicle is in its autopilot mode, the vehicle may be able to drive safely without manual intervention in most highway situations. However, a human driver may be involved in monitoring road conditions in other situations, such as when driving though an inner city.

As such, the interior of self-driving autonomous vehicles represents a new and unique environment. Additionally, this new environment represents a new and growing commercial market.

However, there are few products or systems that are currently designed to take advantage of this market. There are few products that can take advantage of the additional freedoms that the passengers of these vehicles have.

Accordingly, there is a need for a personalized computer system for autonomous vehicles that can utilize the interior environment of these vehicles to enhance a passenger's entertainment experience and/or productivity, while the vehicles are driving in their auto-pilot modes.

### BRIEF DESCRIPTION

The present disclosure offers advantages and alternatives over the prior art by providing a computer system for an autonomous vehicle. The computer system includes display systems that may be disposed on windows of the vehicle. The display systems may be activated when an auto-pilot system of the vehicle is activated. The display systems are independent from one another and are fully interactive with the passengers. As such, by way of example, movies for entertainment purposes or board meetings for business purposes can be conducted and/or provided though the computer system when the auto-pilot system of the vehicle is activated.

A computer system for an autonomous vehicle in accordance with one or more aspects of the present disclosure includes a display system for interfacing with a passenger within the vehicle. The display system is disposed on a window of the autonomous vehicle. A server is disposed in the vehicle. The server is in communication with the display system. The server is operable to activate the display system when an auto-pilot system of the autonomous vehicle is activated.

Another computer system for an autonomous vehicle in accordance with one or more aspects of the present disclosure includes a server disposed in the autonomous vehicle. The computer system also includes a display system for interfacing with a passenger within the autonomous vehicle. The display system is disposed on a window of the autonomous vehicle and is in communication with the server such that the server is operable to activate and deactivate the display system. The display system includes a display screen and a self-tinting screen. The display screen is operable to display content provided by the server when the display system is activated by the server. The self-tinting screen is operable to prevent external light from penetrating the window when the display system is activated by the server. The self-tinting screen is also operable to allow the external light to penetrate the window when the display system is deactivated by the server.

A computer implemented method of providing content to passengers of an autonomous vehicle in accordance with one or more aspects of the present disclosure is presented. The vehicle includes a computer system having display systems disposed on passenger windows and a windshield of the vehicle. The vehicle further includes an auto-pilot system with an autonomous driving mode in communication with the computer system. The method includes:
a. determining if the auto-pilot system is activated when the computer system is powered on if the auto-pilot system is semi-autonomous;
b. enabling the display system when the auto-pilot system is activated; and
c. disabling the display system if the auto-pilot system is deactivated.

### DRAWINGS

The disclosure will be more fully understood from the following detailed description taken in conjunction with the accompanying drawings, in which:

FIG. 1 is an example of an interior of an autonomous vehicle including a computer system having independent display systems disposed on passenger windows and a windshield of the vehicle in accordance with the present disclosure;

FIG. 2 is an example of the computer system of FIG. 1 wherein an auto-pilot system of the vehicle is activated and the display systems disposed on the passenger windows and on the windshield window are enabled in accordance with the present disclosure;

FIG. 3 is an example of cell phone having a display screen system application installed, wherein the application enables the cell phone to function as a remote control device for the display systems of FIG. 2;

FIG. 4 is an example of a display system in accordance with the present disclosure;

FIG. 5 is an example of a basic block diagram of a computer system in accordance with the present disclosure;

FIG. 6 is an example of a high level logic flow diagram of software logic used to implement a computer system in accordance with the present disclosure; and

FIG. 7 is an example of a block diagram of a computer sub-system of a computer system in accordance with the present disclosure.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

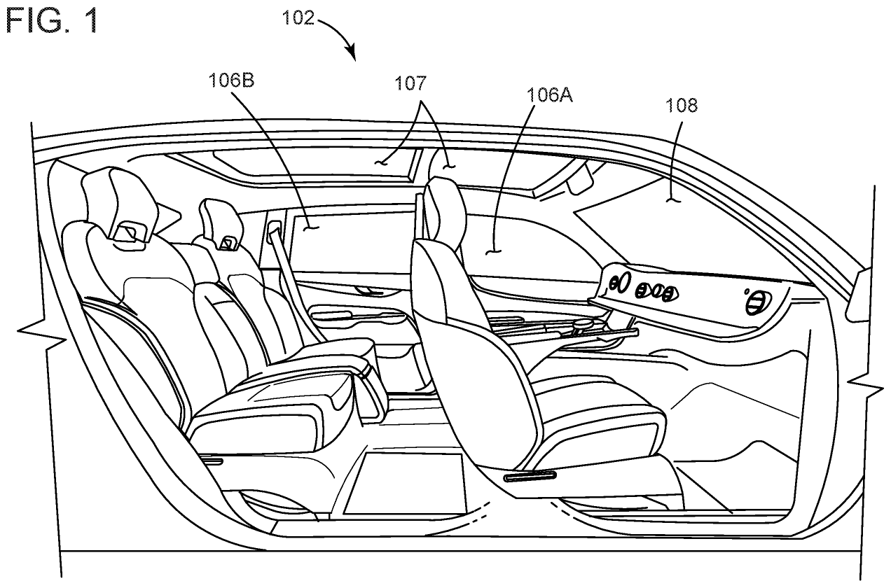

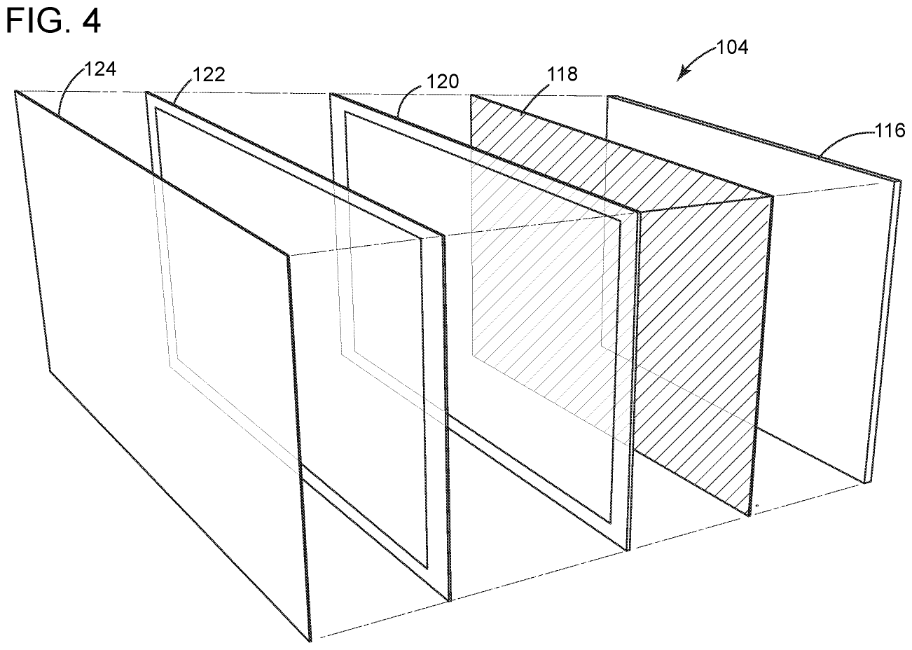

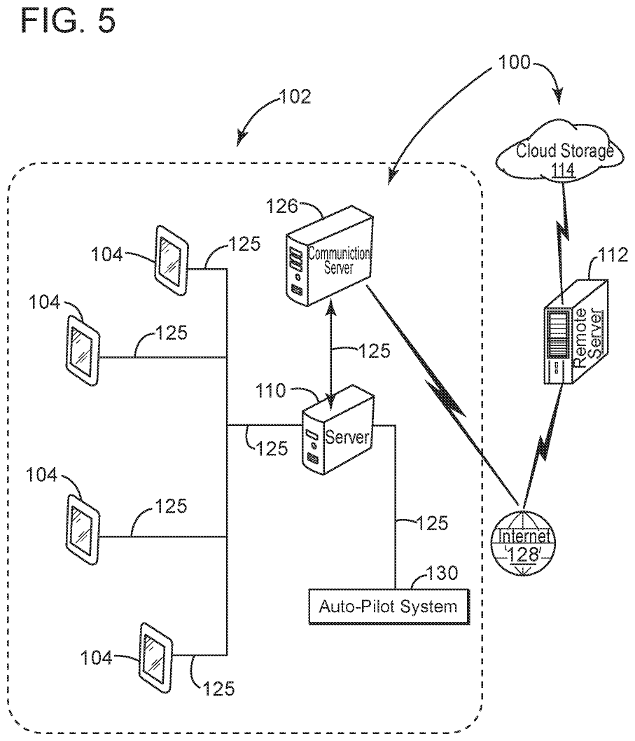

Referring to FIG. 1, an example of an interior of an autonomous vehicle 102 including a computer system 100 (best seen in FIG. 5) having independent display systems 104 (best seen in FIG. 4) disposed on one or more windows (for example, front seat passenger windows 106A, rear seat passenger windows 106B, sun roof windows 107 and windshield window 108) of the vehicle 102 in accordance with the present disclosure is presented. The vehicle 102 includes an auto-pilot system 130 (best seen in FIG. 5) that may have a fully autonomous driving mode wherein the vehicle is capable of fully and safely self-driving itself without any manual operation or input. Alternatively, the vehicle 102 may include an auto-pilot system 130 that may have a semi-autonomous driving mode wherein the vehicle is capable of fully and safely self-driving itself in some situations (such as highway driving), but may involve the participation of a human in other situations (such as inner city driving).

Also alternatively, in some situations, the vehicle 102 may be non-autonomous and may not include an auto-pilot system 130. In the case of a non-autonomous vehicle, the vehicle 102 may involve being driven manually in all situations.

The auto-pilot system 130 may include a system of multiple sensors (not shown) placed around the vehicle 102. The sensors may enable the vehicle 102 to sense and understand its environment so that the vehicle can safely drive itself in most (for semi-autonomous vehicles), if not substantially all (for fully autonomous vehicles), driving situations. The auto-pilot system sensors may include radar, cameras, digitally-controlled electric assist braking systems, ultrasonic sensors, a global positioning system and the like.

The auto-pilot system 130 may be activated (enabled) in a variety of ways. For example, the auto-pilot system 130 may be activated automatically as soon as the vehicle is turned on, may be activated when the vehicle senses that a passenger has entered the vehicle and the vehicle doors are properly closed or may be activated manually by pulling on a switch.

The autonomous vehicle 102 may be any vehicle that has self-driving capabilities, whether they be fully autonomous or semi-autonomous. For example, an autonomous vehicle 102 may be an automobile, a truck or other ground transportation vehicle. Also, for example, the autonomous vehicle may be an aerial autonomous vehicle capable of flight, such as a propeller or jet driven air taxi. Additionally, the autonomous vehicle may be a ship capable of transport over water.

The display systems 104 on each of windows 106A, 106B, 108 are operable to interface with the passengers of the vehicle 102. The computer system 100 may also include a server 110 (best seen in FIG. 5), which can be at least one server or multiple servers, that is disposed in the vehicle 102. The server 110 may be in communication with the display systems 104 and may be in communication with the auto-pilot system 130 of the vehicle 102. The server 110 may enable (activate) the display systems 104 when the auto-pilot system 130 is activated (enabled) and may disable (deactivate) the display systems 104 when the auto-pilot system is deactivated (disabled).

Alternatively, in autonomous vehicles that are designed to operate entirely in a fully autonomous driving mode, the server 110 may not be in communication, or may not be in constant communication, with an auto-pilot system. This is because there may be limited need to disable the display systems 104 if the vehicle is in a manual operating mode, since the vehicle 102 may always be in a fully autonomous driving mode.

In the example of FIG. 1, the vehicle 102 is designed for fully autonomous driving, wherein the auto-pilot system 130 is always active and the vehicle 102 has no manual driving mode. Accordingly, the vehicle 102 in FIG. 1 is illustrated without a steering wheel or foot pedals for manual control. Alternatively, the vehicle 102 may be designed for semi-autonomous driving and may have a manual driving mode. Accordingly, there may be a steering wheel and foot pedals installed for manual control.

Additionally, in the example of FIG. 1, the display system 104 is turned off (disabled). The display system 104 may be disabled, for example, via a manual switch in a fully autonomous vehicle. Alternatively, if vehicle 102 where semi-autonomous, the display system 104 may be disabled automatically by server 110 because the server 110 has received signals from one or more sensors that indicate that the auto-pilot system 130 is deactivated. Accordingly, the windows 106A, 106B, 108 may function normally and the passengers can view the outside environment through the windows 106A, 106B, 108 while the vehicle 102 drives itself or is driven manually.

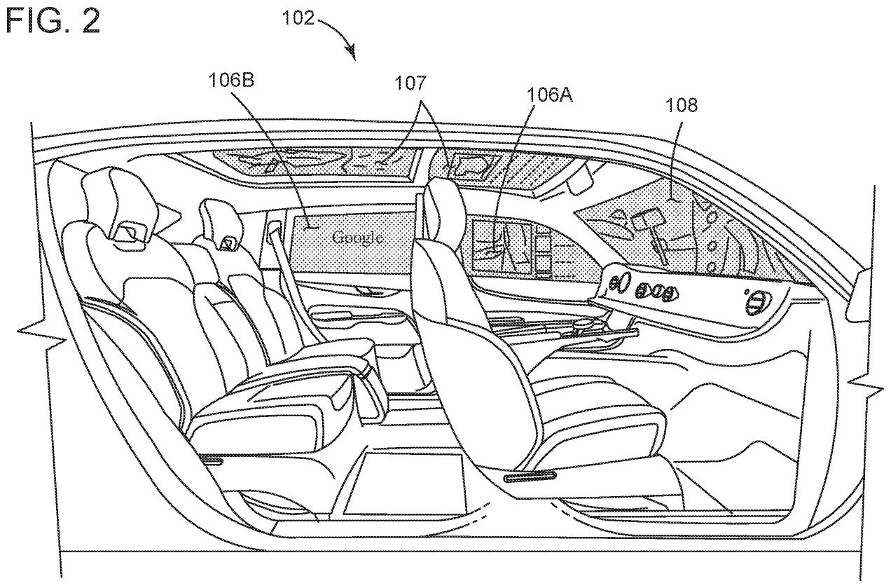

Referring to FIG. 2, an example of the computer system 100 of FIG. 1 is illustrated wherein the auto-pilot system 130 is activated and the display systems 104 disposed on the front and rear passenger windows 106A, 106B (collectively the passenger windows 106) and on the windshield window 108 are enabled. When the display systems (or displays) 104 are enabled, a self-tinting screen 116 (best seen in FIG. 4) of the display system 104 may darken to limit or prevent external light from entering through the widow that the display system 104 is dispose on. By doing so, the self-tinting screen (layer) 116 enhances the clarity of content (or content data) being displayed on the display system 104 by reducing the amount of external light that can distract or obscure a passenger's view of the content. External light, as used herein, includes light that enters the interior of the vehicle from outside of the vehicle.

Additionally, when the display system 104 is activated, various applications and other content data can be accessed through the display system 104, just as a passenger/user could access an application and/or content data through a personal computer, a cell phone or the like. In the example of FIG. 2, a Google search page is being accessed on a rear seat passenger window 106B, while a movie is being played on a front seat passenger window 106A and another movie is being played on the windshield 108.

Alternatively, the display systems 104 may be enabled for some, but not all, of the windows 106, 108. For example, the display systems 104 may be enabled for just the rear seat passenger windows 106B, while the display systems 104 for the front seat passenger windows 106A and windshield 108 are turned off. Optionally, if the display systems 104 for the front seat passenger windows 106A and the windshield window 108 are disabled, the vehicle may be driven in a manual mode (or the vehicle may be non-autonomous altogether) while the display systems 104 for the rear seat passenger windows 106B are still enabled and actively displaying content.

Moreover, the display system 104 may be enabled for a rear window (not shown) of an autonomous vehicle as well. For example, in a van or sport utility vehicle (SUV) with autonomous driving capabilities, it may be ergonomically convenient for passengers to access the display system on the rear window of the vehicle.

Additionally, the display system 104 may be enabled for a sun roof window 107 of a non-autonomous vehicle 102. This is because, the display system 104 may not impair a driver's view of the road if it is disposed solely on a sun roof window 107. Therefore, a driver in a non-autonomous vehicle 102 (wherein there is no auto-pilot system 130 and may involve being manually driven in all situations) can safely drive, while the passengers enjoy the content displayed by the display system 104 on a sun roof window 107. Further, the self-tinting screen 116 of the display system 104 may prevent the glare of some or all of the sun light from penetrating the sun roof window 107 and interfering with the passenger's view of the content when the display system 104 is activated.

If the auto-pilot system 130 of a semi-autonomous vehicle 102 is not activated, the software of the computer system 100 may prevent accessibility to the display system 104 entirely. However, once the auto-pilot system 130 is activated, wherein the semi-autonomous vehicle 102 can be safely relied upon to drive without the aid of manual controls, the display system 104 may be enabled. Accordingly, each of the displays 104 may be utilized by the passengers as their own personalized computer system to enhance a passenger's entertainment experience and/or productivity, while the vehicle is driving in its auto-pilot mode.

For example, the displays (or display systems) 104 on the passenger windows 106 may be used for personal entertainment, such as movies, or for access to other personal applications. Also, by way of example, the display 104 on the windshield window 108 may be used as the main screen for the entire vehicle and can be used to conduct business functions, such as board meetings, or other group oriented business or personal functions.

The computer system 100 is operable such that each display system 104 functions independently of each other. However, content data (such as applications, information, movies, music, documents or the like) on one display system 104 disposed on one window 106, 108 may be mirrored (or dragged) to another display system 104 disposed on another window 106, 108. Further, the display system 104 on the windshield 108 may be controlled by a track pad, cell phone or other similar device for ergonomic ease of control of the display 104.

The computer system can store personal information, documents, applications or other content specific to a passenger on the at least one server 110 or on a memory stored on the computer system's 100 server 110 (or servers), on a remote server, such as a company server 112 (best seen in FIG. 5), or on a cloud storage memory system 114 (such as a bank of cloud servers) (best seen in FIG. 5). Further, the computer system can protect personal information of a passenger by prompting a passenger for his finger print, a password and user name, or the like.

Additionally, the autonomous vehicle 102 may be altered to make the display system 104 more ergonomically accessible to a passenger. For example, the passenger seats of the vehicle may be designed to swivel so that a passenger would not have to turn his or her neck as much to view the display system 104.

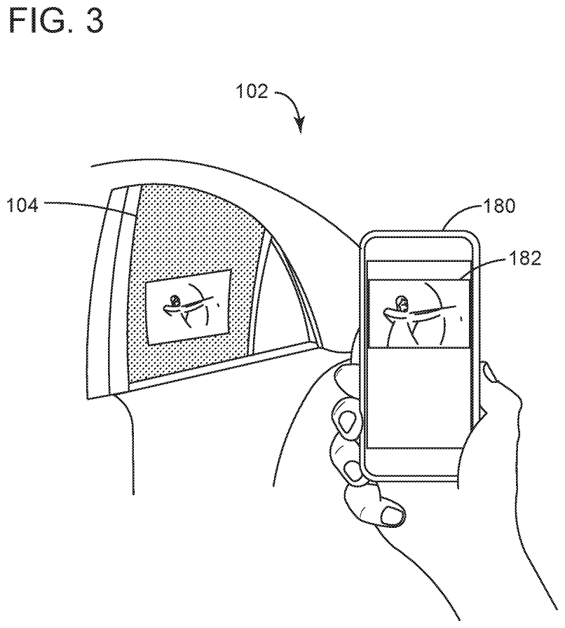

Referring to FIG. 3, an example of a cell phone 180 having a display system application (or “app.”) 182 installed, wherein the app. 182 enables the cell phone 180 to function as a remote control for the display system 104, is presented. As an alternative to controlling the display system 104 with a touch pad or other device that is integrated into the structure of the vehicle 102, the display system 104 may be controlled by the display system app 182 that could be downloaded onto a passenger's cell phone 180.

The display system app 182 may include access to other applications, much like an app store type application. The other applications may include applications for Netflix, Power Point, maps, weather, television, movies, browsers or the like. Once the display system app. 182 is engaged, a passenger may use a finger or other pointer device to scroll through the other applications on the phone 180. The other applications may be displayed on the cell phone, on the display system 104 or on both. Once the display system app 182 is turned off, the cell phone 180 may return to its normal function.

Though the cell phone 180 having the display system application 182 is illustrated in this example as a remote control device for the display system 104, other remote control devices may also be used to control the display system 104. For example, the display system 104 may be in communication with a dedicated remote control device used solely for control of the display system 104. Alternatively, a wireless mouse (not shown), or other similar device, may be used as a remote control device to control the display system 104.

Referring to FIG. 4, an example of the display system 104 is illustrated in accordance with the present disclosure. In this example, the display system 104 includes a self-tinting screen 116, a backlighting screen 118, a display screen 120, a touch screen 122 and a protective screen 124.

The purpose of the self-tinting screen 116 is meant to darken or lighten the exterior glass windows 106, 108 of the vehicle 102 to increase the privacy of the vehicle 102, particularly when the display system 104 is activated. In some cases, the self-tinting screen 116 enhances the entertainment experience and/or functionality of the computer system 100 by not letting external light penetrate the self-tinting screen 116 when the display system is activated.

In some circumstances, for example in a semi-autonomous vehicle, when the display system 104 is activated on the windshield 108 or when the display system is activated on all windows simultaneously, the self-tinting screen 116 may be able to be controlled and used only when the autopilot system is activated. The semi-autonomous vehicle 102 may have to be operating in auto pilot mode, such that it is fully and completely driving itself, before the tinting feature of the self-tinting screen 116 can be activated. In other circumstances, for example when the display system is activated in a rear window or side rear passenger windows 106B, the self-tinting screen 116 may be in use when the semi-autonomous vehicle 102 is operating in a manual mode.

Once activated, the passenger windows 106 and the windshield window 108 are allowed to be darkened so that the passengers can enjoy the display system 104 without distractions of external lighting. This tinting feature may be turned off at any time so the passengers can check on the exterior circumstances of the vehicle. This may be accomplished by incorporating such technologies as Smart Tint® made by Smart Tint, Inc. of Stony Brook, New York or the like.

The backlighting screen 118 feature is a source of illumination that enables the content shared on the display system 104 to be more seeable. This may be a thin layer (or screen) that cooperates with the display screen 120 to enhance the visibility of the display screen 120. Alternatively, the source of backlighting illumination may come from other areas of the vehicle. For example, the backlighting illumination may come from within a frame of a door of the vehicle that supports the window 106 that the display system 104 is disposed on.

The purpose of the display screen 120 is to be the screen (or layer) of the display system 104 in which the lighting and color is produced so that every aspect of the applications run or other content displayed on the computer system 100, whether it be a movie, a document, a game or the like, can be clearly seen by a passenger. The display screen 120 may be a liquid crystal display (LCD) screen, an organic liquid crystal display (OLCD) screen, a light emitting diode (LED) screen, an organic light emitting diode (OLED) screen or the like.

The purpose of the touch screen 122 is to enable the passenger/user to interact with the display system 104 via touch. Alternatively, a passenger may interact with the display system 104 via a touch pad, cell phone or other similar device. In the case of the display system 104 disposed on the passenger windows 106, the touch screen 122 would enable a passenger to ergonomically easily reach and utilize the display system 104. In the case of the display system 104 disposed on the windshield 108, a touch pad or similar device mounted on a center console between the two front vehicle 102 seats may enable a passenger to more ergonomically easily control the display system 102 than the touch screen 122 feature. Accordingly, the touch screen 122 may not be utilized on the display system 104 disposed on the windshield 108.

Alternatively, a passenger may interact with the display system 104 via the touch screen on a cell phone 180 that contains the display system app. 182 as discussed herein with reference to FIG. 3. Accordingly, the touch screen 122 may not be utilized on the display system 104, when it is controlled remotely by, for example, a cell phone 180 or another remote control device.

The protective screen 124 is meant to serve as a guard to all of the other screens 122, 120, 118, 116. This is especially the case for the touch screen 122.

Referring to FIG. 5, an example of a basic block diagram of the computer system 100 in accordance with the present disclosure is illustrated. In this example of the computer system 100, the display systems 104 are in communication with a server 110 via a system bus 125 that may be hardwired into the vehicle 102.

The server 110 may be disposed in the vehicle 102 and may also be in communication with the auto-pilot system 130 of the vehicle 102 through the system bus 125. The server 110 may also cache all visited pages and links on the internet 128.

The server 110 may also be connected (for example, either directly or indirectly through other servers, or other sub-computer systems) to a variety of sensors that detect various parameters and send signals to the server 110 indicative of the state of those parameters. The state of the parameters may enable the server 110 to determine whether or not the display system 104 should be enabled or disabled. For example, the server 110 may be electrically connected to a sensor on the vehicle door. The sensor may detect if the door is open (a broken connection in an open circuit) or closed (a closed connection in a closed circuit). If the door is detected by the server to be closed, the server may send an activation signal over the system bus 125 to activate the display system 104. The display system 104 may then prompt a passenger to provide an indication (such as touching an icon on the touch screen 122 of the display system 104, or pressing a key on a cell phone) as to whether the passenger wants to further interact with the display system 104, or wants to turn the display system off. The sensors (not shown) may be current sensors, voltage sensors, capacitance sensors or the like. The sensors may be considered input devices to the server 110. The activation signal may be, for example, a voltage signal generated from a voltage output device controlled by the server 110.

The server 110 (which may be, for example, a proxy server) may also act as an intermediary between the display system 104 and other servers or sub-computer systems, accepting incoming traffic from the display system 104 and sending it to the other servers or sub-computer systems. Reasons for utilizing the server 110 in this way may include content control and filtering, improved traffic performance, prevention of unauthorized network access or simply routing the traffic over a large and complex network.

The server 110 may also be connected by the system bus 125 to a communication server 126, which may also be disposed in the vehicle 102. The communication server 126 may be used to maintain an environment needed for one communication endpoint (such as the display system 104 or server 110) to find other endpoints (such as other servers or sub-computer systems) and communicate with them. It may include a directory of communication endpoints and a presence detection service, depending on the openness and security parameters of the network 128 that the communication server 126 is communicating through.

The communication server 126, in this embodiment, may be in wireless communication with a remote server 112 (or multiple remote servers), which are located outside of the vehicle, through the internet 128. For example, the remote server 112, may be a remote company server 112 located on a facility of a company supporting computer system 100. The remote server 112 may function similarly to that of an Amazon/Microsoft cloud system or similar. However, the remote server 112 may be able to add additional levels of security over that of an Amazon/Microsoft cloud system for the passengers using the computer system 100.

The remote server 112 may be in wireless communication with a cloud storage system 114, which may store personal information and other content from the passengers of the vehicle 102. The cloud storage system 114 may include a network of remote servers, often hosted on the Internet, to store, manage, and process data. The information may be retrieved by the passengers after logging in and submitting a password, a specific fingerprint or similar secure identification means.

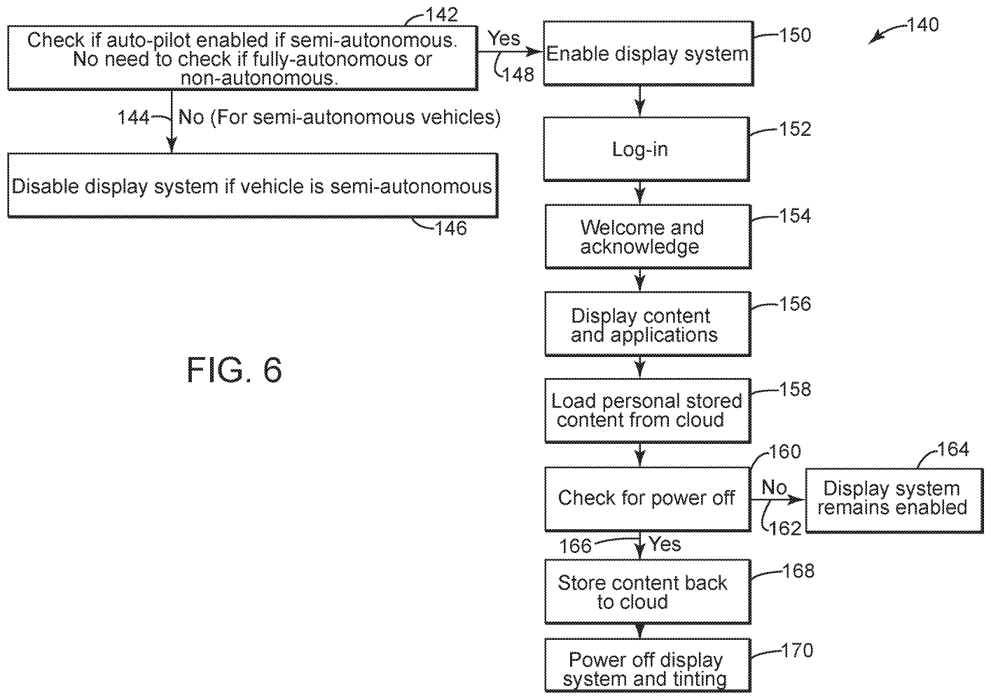

Referring to FIG. 6, an example of a high level logic flow diagram 140 of the software process used to implement the computer system 100 in accordance with the present disclosure is illustrated. As discussed earlier, the computer system 100 has at least one server 110 in communication with at least one display system 104, wherein the display system 104 is disposed on at least one window 106, 108. The server 110 of the computer system 100 may also be in communication with an auto-pilot system of the autonomous vehicle 102, especially when the vehicle 102 is a semi-autonomous vehicle. When passengers enter the vehicle 102, the display system 104 may be disabled and inactive. Therefore, the window 106, 108 that the display system is disposed on functions as normal to allow a clear view of the outside of the vehicle 102.

The process begins at 142 of flow diagram 140, wherein, once the computer system 100 is powered on, the auto-pilot system 130 may be checked to determine if the auto-pilot system is activated. Alternatively, especially in the case of a fully autonomous vehicle 102, the computer system 100 may have no need to check if the auto-pilot system 130 is activated, because it may always be activated.

If, as in 144, the software determines that the auto-pilot system 130 of, for example, a semi-autonomous vehicle 102, is not activated, then the software may proceed to 146, wherein the display system may be disabled.

If, as in 148, the software determines that the auto-pilot system 130 is activated (or in the case of a fully autonomous vehicle, the auto-pilot system is always activated when the vehicle 102 starts up), then the software proceeds to 150, wherein the display system 104 may be enabled. Therefore the tint screen 116 may function to darken the windows 106, 108 to increase the privacy within the interior of the vehicle 102 and to allow the content displayed on the display systems 104 to be clearly viewed.

Proceeding to 152, the display system 104 may prompt the passenger for security information, such as a fingerprint or password or username, in order to allow the passenger to log into the computer system 100. Once a passenger successfully logs in the software may proceed to 154 where it may welcome the passenger with a sound, a message or the like to acknowledge that the system 100 has identified the passenger. Once a passenger is identified, the software may proceed to 156, wherein the computer system 100 displays a variety of applications and/or other content on its display system 104 that are personal to the passenger.

Proceeding to 158, the software may load a specific passenger's documents, information and other content from cloud storage system 114 that the computer system 100 is in communication with.

The software of the computer system 100 may continue to interact with the passenger and may continuously check to determine if the passenger has powered the system 100 off, at 160. If, as in 162, the software determines that the passenger has not powered the system 100 off, then the software may proceed to 164, wherein the display system 104 remains powered on and active.

If, as in 166, the software determines that the passenger has powered the computer system 100 off, then the following two procedures may be executed:
a. at 168, the passengers information and other personal content may be saved back into the cloud storage system 114 and cleared from the display system 104; and
b. at 170, the display system 104, including the tint features of the tint screen 116, may be disabled and powered off.

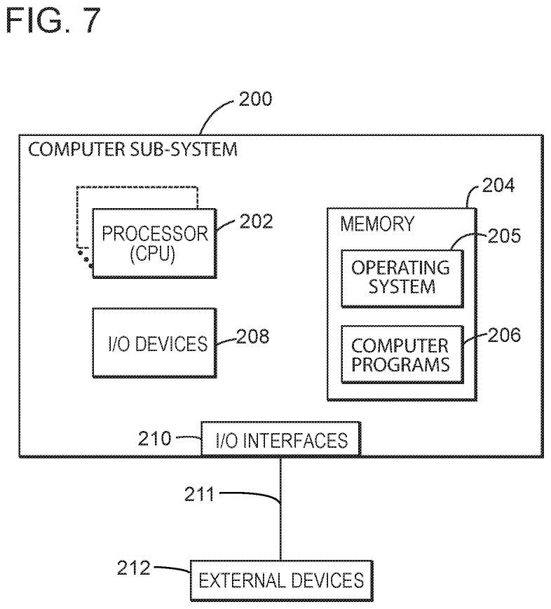

Aspects of computer system 100, as described herein, may be performed singly or collectively by one or more computer sub-systems, such as one or more servers, cloud servers, computing systems, or combination of the foregoing, as examples. FIG. 7 depicts one example of such a computer sub-system and associated devices to incorporate and/or use aspects described herein. A computer sub-system may also be referred to herein as a data processing device/system, computing device/system/node, or simply a computer. The computer sub-system may be based on one or more of various system architectures and/or instruction set architectures, such as those offered by Intel Corporation (Santa Clara, Calif., USA) or ARM Holdings plc (Cambridge, England, United Kingdom), as examples.

FIG. 7 shows a computer sub-system 200 in communication with external device(s) 212. Computer sub-system 200 includes one or more processor(s) 202, for instance central processing unit(s) (CPUs). A processor can include functional components used in the execution of instructions, such as functional components to fetch program instructions from locations such as cache or main memory, decode program instructions, and execute program instructions, access memory for instruction execution, and write results of the executed instructions. A processor 202 can also include register(s) to be used by one or more of the functional components. Computer sub-system 200 also includes memory 204, input/output (I/O) devices 208, and I/O interfaces 210, which may be coupled to processor(s) 202 and each other via one or more buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 204 can be or include main or system memory (e.g. Random Access Memory) used in the execution of program instructions, storage device(s) such as hard drive(s), flash media, or optical media as examples, and/or cache memory, as examples. Memory 204 can include, for instance, a cache, such as a shared cache, which may be coupled to local caches (examples include L1 cache, L2 cache, etc.) of processor(s) 202. Additionally, memory 204 may be or include at least one computer program product having a set (e.g., at least one) of program modules, instructions, code or the like that is/are configured to carry out functions of embodiments described herein when executed by one or more processors.

Memory 204 can store an operating system 205 and other computer programs 206, such as one or more computer programs/applications that execute to perform aspects described herein. Specifically, programs/applications can include computer readable program instructions that may be configured to carry out functions of embodiments of aspects described herein.

Examples of I/O devices 208 include but are not limited to microphones, speakers, Global Positioning System (GPS) devices, cameras, lights, accelerometers, gyroscopes, magnetometers, sensor devices configured to sense light, proximity, heart rate, body and/or ambient temperature, blood pressure, and/or skin resistance, and activity monitors. An I/O device may be incorporated into the computer system as shown, though in some embodiments an I/O device may be regarded as an external device (212) coupled to the computer system through one or more I/O interfaces 210.

Computer sub-system 200 may communicate with one or more external devices 212 via one or more I/O interfaces 210. Example external devices include a keyboard, a pointing device, a display, and/or any other devices that enable a user to interact with computer sub-system 200. Other example external devices include any device that enables computer sub-system 200 to communicate with one or more other computing systems or peripheral devices such as a printer. A network interface/adapter is an example I/O interface that enables computer sub-system to communicate with one or more networks, such as a local area network (LAN), a general wide area network (WAN), and/or a public network (e.g., the Internet), providing communication with other computing devices or systems, storage devices, or the like. Ethernet-based (such as Wi-Fi) interfaces and Bluetooth® adapters are just examples of the currently available types of network adapters used in computer systems (BLUETOOTH is a registered trademark of Bluetooth SIG, Inc., Kirkland, Wash., U.S.A.).

The communication between I/O interfaces 210 and external devices 212 can occur across wired and/or wireless communications link(s) 211, such as Ethernet-based wired or wireless connections. Example wireless connections include cellular, Wi-Fi, Bluetooth®, proximity-based, near-field, or other types of wireless connections. More generally, communications link(s) 211 may be any appropriate wireless and/or wired communication link(s) for communicating data.

Particular external device(s) 212 may include one or more data storage devices, which may store one or more programs, one or more computer readable program instructions, and/or data, etc. Computer sub-system 200 may include and/or be coupled to and in communication with (e.g. as an external device of the computer system) removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media.

Computer sub-system 200 may be operational with numerous other general purpose or special purpose computing system environments or configurations. Computer sub-system 200 may take any of various forms, well-known examples of which include, but are not limited to, personal computer (PC) system(s), server computer system(s), such as messaging server(s), thin client(s), thick client(s), workstation(s), laptop(s), handheld device(s), mobile device(s)/computer(s) such as smartphone(s), tablet(s), and wearable device(s), multiprocessor system(s), microprocessor-based system(s), telephony device(s), network appliance(s) (such as edge appliance(s)), virtualization device(s), storage controller(s), set top box(es), programmable consumer electronic(s), network PC(s), minicomputer system(s), mainframe computer system(s), and distributed cloud computing environment(s) that include any of the above systems or devices, and the like.

The present disclosure may be a system, a method, and/or a computer program product, any of which may be configured to perform or facilitate aspects described herein.

In some embodiments, aspects of the present disclosure may take the form of a computer program product, which may be embodied as computer readable medium(s). A computer readable medium may be a tangible storage device/medium having computer readable program code/instructions stored thereon. Example computer readable medium(s) include, but are not limited to, electronic, magnetic, optical, or semiconductor storage devices or systems, or any combination of the foregoing. Example embodiments of a computer readable medium include a hard drive or other mass-storage device, an electrical connection having wires, random access memory (RAM), read-only memory (ROM), erasable-programmable read-only memory such as EPROM or flash memory, an optical fiber, a portable computer disk/diskette, such as a compact disc read-only memory (CD-ROM) or Digital Versatile Disc (DVD), an optical storage device, a magnetic storage device, or any combination of the foregoing. The computer readable medium may be readable by a processor, processing unit, or the like, to obtain data (e.g. instructions) from the medium for execution. In a particular example, a computer program product is or includes one or more computer readable media that includes/stores computer readable program code to provide and facilitate one or more aspects described herein.

As noted, program instruction contained or stored in/on a computer readable medium can be obtained and executed by any of various suitable components such as a processor of a computer system to cause the computer system to behave and function in a particular manner. Such program instructions for carrying out operations to perform, achieve, or facilitate aspects described herein may be written in, or compiled from code written in, any desired programming language. In some embodiments, such programming language includes object-oriented and/or procedural programming languages such as C, C++, C#, Java, etc.

Program code can include one or more program instructions obtained for execution by one or more processors. Computer program instructions may be provided to one or more processors of, e.g., one or more computer sub-systems, to produce a machine, such that the program instructions, when executed by the one or more processors, perform, achieve, or facilitate aspects of the present disclosure, such as actions or functions described in flowcharts and/or block diagrams described herein. Thus, each block, or combinations of blocks, of the flowchart illustrations and/or block diagrams depicted and described herein can be implemented, in some embodiments, by computer program instructions.

Although the disclosure has been described by reference to specific embodiments, it should be understood that numerous changes may be made within the spirit and scope of the inventive concepts described. Accordingly, it is intended that the disclosure not be limited to the described embodiments, but that it have the full scope defined by the language of the following claims.

What is claimed is:

1. A computer system for an autonomous vehicle, the computer system comprising:
a display system for interfacing with a passenger within the autonomous vehicle, the display system disposed on a window of the autonomous vehicle; and
a server disposed in the vehicle, the server in communication with the display system;
wherein the server is operable to activate the display system based on an auto-pilot system of the autonomous vehicle being activated.

2. The computer system of claim 1, wherein:
the server is in communication with the auto-pilot system; and
the server is operable to deactivate the display system based on the auto-pilot system being deactivated.

3. The computer system of claim 1, wherein the display system is disposed on a plurality of passenger windows and on a front windshield of the vehicle.

4. The computer system of claim 3, wherein the computer system is configured to move content displayed on the display system to another display system disposed on another window of the autonomous vehicle based on receiving user input that the content is to be moved.

5. The computer system of claim 1, wherein the server is operable to access content stored in a memory and display the content on the display system, thereby providing a passenger access to the content through the display system.

6. The computer system of claim 1, wherein the display system comprises:
a self-tinting screen operable to prevent external light from penetrating the window based on the display system being activated by the server and operable to allow the external light to penetrate the window based on the display system being deactivated by the server; and
a display screen operable to display content provided by the server based on the display system being activated by the server.

7. The computer system of claim 6, wherein the display system comprises a touch screen and a protective screen.

8. The computer system of claim 6, wherein a source of backlighting illumination for the display screen originates from one of a backlighting screen and a frame of a door of the vehicle.

9. The computer system of claim 1, wherein the display system is operable to be controlled at least in part by a cell phone having a display system application installed therein, the display system application providing access to other applications that can be displayed on the display system.

10. The computer system of claim 1, wherein the server comprises:
a proxy server disposed in the vehicle, the proxy server in communication with the display system; and
a communication server disposed in the vehicle, the communication server in communication with the proxy server and a wide area network.

11. The computer system of claim 1, wherein:
the server is connected to a sensor, the sensor being operable to detect whether a vehicle door is open or closed; and
the server is operable to activate the display system based on the door being closed.

12. A computer system for a vehicle, the computer system comprising:
a server disposed in the vehicle; and
a display system for interfacing with a passenger within the vehicle, the display system being disposed on a window of the vehicle and being in communication with the server such that the server is operable to activate and deactivate the display system, the display system comprising:
a display screen operable to display content provided by the server based on the display system being activated by the server; and
a self-tinting screen operable to prevent external light from penetrating the window based on the display system being activated by the server and operable to allow the external light to penetrate the window based on the display system being deactivated by the server.

13. The computer system of claim 12, wherein the vehicle is an autonomous vehicle and the server is operable to activate the display system based on an auto-pilot system of the autonomous vehicle being activated.

14. The computer system of claim 13, wherein the server is in communication with the auto-pilot system such that the server is operable to deactivate the display system based on the auto-pilot system being deactivated.

15. The computer system of claim 12, wherein the display system is disposed on at least one of a windshield window, a rear window, a sun roof window and a passenger window of the vehicle.

16. The computer system of claim 15, wherein the vehicle is a non-autonomous vehicle and the display system is disposed on the sun roof window.

17. The computer system of claim 12, wherein the display system is controlled at least in part by a cell phone having a display system application installed therein, the display system application providing access to other applications that can be displayed on the display system.

18. A computer implemented method of providing content to passengers of an autonomous vehicle, the vehicle including a computer system having a display system disposed on a window of the vehicle, and further including an auto-pilot system, having an autonomous driving mode, in communication with the computer system, the method comprising:
determining whether the auto-pilot system is activated; and
enabling the display system based on determining that the auto-pilot system is activated.

19. The method of claim 18, further comprising:
tinting the window, wherein the tinting prevents external light from penetrating the window, thereby reducing the amount of external light entering the interior of the vehicle to enhance clarity of content displayed on the display system and increase privacy of an interior of the vehicle.

20. The method of claim 19, further comprising:
prompting a passenger of the vehicle for security information to identify the passenger and to log the passenger into the computer system;
acknowledging that the passenger has been identified by the computer system based on the passenger successfully logging into the computer system;
accessing content personal to the passenger from a cloud storage system; and
displaying the accessed content on the display system.
